(19) United States
(12) Patent Application Publication
(10) Pub. No.: US 2019/0172630 A1
(43) Pub. Date: Jun. 6, 2019

(54) COIL DEVICE

(71) Applicant: TDK CORPORATION, Tokyo (JP)

(72) Inventors: Yugo ASAI, Tokyo (JP); Tsutomu KOBAYASHI, Tokyo (JP); Daisuke URABE, Tokyo (JP); Hiroshi SUZUKI, Tokyo (JP)

(73) Assignee: TDK CORPORATION, Tokyo (JP)

(21) Appl. No.: 16/190,819

(22) Filed: Nov. 14, 2018

(30) Foreign Application Priority Data
Nov. 16, 2017 (JP) 2017-220698
Oct. 18, 2018 (JP) 2018-197019

(51) Int. Cl. H01F 27/29; H01F 17/04; H01F 27/28

(52) U.S. Cl. CPC H01F 27/29; H01F 2017/0093; H01F 27/2823; H01F 17/04

(57) ABSTRACT

A coil device having excellent mode conversion property which can be suitably used as a common mode filter. The coil device has a core, a first collar part and a second collar part provided to both sides of the core in axis direction, a coil part at least having a first wire and a second wire which are wound around the core, and terminals provided to the collar parts. One lead part of the wire heading towards the coil part from the terminals, and one lead part of the wire heading towards the coil part from the second terminal are placed in close proximity at least between an inner face of the collar part and the coil part.

### BACKGROUND OF THE INVENTION

The present invention relates to a coil device used for example as a coil type common mode field and the like.

As a common mode choke coil used as the coil type common field filter and the like, for example a coil device shown in following Patent document 1 is known. In this coil device, an improvement of a mode conversion property is proposed.

In the coil device used as a conventional common mode filter and the like, many of them are structured to have a wire connecting part on the mounting face as shown in Patent document 1. When the wire connecting part is present on the mounting face, heat of a solder during mounting may have adverse effect on the wire connecting part, thus a heat-resistant wire needs to be used. Also, it is difficult to attain a structure having strong thermal shock resistance.

Thus, a coil device in which wires are connected at an opposite face of the mounting face is proposed. However, when using the coil device in which the wires are connected at the opposite face of the mounting face to the common field filter and the like, a risk of compromising the mode conversion property was confirmed.

Patent document 1: JP Patent Application Laid Open No. 2017-112156

### SUMMARY OF THE INVENTION

The present invention is attained in view of such circumstances, and the object thereof is to provide a coil device capable of being suitably used as a common mode filter having excellent mode conversion property.

In order to attain the above object, the coil device according to the present invention has

a core,

a first collar part and a second collar part each provided at both sides along the axis direction of the core,

a coil part at least having a first wire and a second wire which are wound around the core,

a first terminal connected with one lead part of the first wire and provided to the first collar part,

a second terminal connected with one lead part of the second wire and provided apart from the first terminal to the first collar part,

a third terminal connected with other lead part of the first wire and provided to the second collar part,

a fourth terminal connected with other lead part of the second wire and provided apart from the third terminal to the second collar part, wherein

the one lead part of the first wire heading towards the coil part from the first terminal and the one lead part of the second wire heading towards the coil part from the second terminal are placed in close proximity at least between the coil part and an inner face of the first collar part, and

the first wire and the second wire form a crossing part of which the first wire and the second wire are crossing against each other in the middle of the core.

As a result of keen study regarding the coil device such as the common field filter and the like by the present inventors, it was found that by placing the one lead part of the first wire heading towards the coil part from the first terminal and the one lead part of the second wire heading towards the coil part from the second terminal in close proximity at least between the inner face of the first collar part and the coil part, and also by providing a crossing part in the middle of the coil part, the mode conversion property can be improved. Thereby, the present invention was attained.

As an index relating to a noise property and a signal quality of the common mode filter, the mode conversion property is used. When the mode conversion property is good, this means that a differential signal is not converted to a common mode and a property as the common mode filter is good. Particularly recently, a data transfer rate is improved, and an excellent mode conversion property is demanded at the data transfer rate of 100 Mbps or more. Particularly, the common mode filter used for Automotive Ethernet™ and the like is demanded to attain a higher performance. According to the coil device of the present invention, the common mode filter capable of corresponding to such demands can be attained.

According to the coil device of the present invention, the mode conversion property improves even when the wire connecting part is placed other than the mounting face. Therefore, the adverse effect to the wire connecting part by heat of a solder during mounting decreases, and the heat resistant wire does not necessarily have to be used as the wire constituting the coil part. Also, since the wire does not necessarily have to be connected to the mounting part, for example a metallic terminal can be provided to the collar part, and the structure having a strong thermal shock resistance can be easily attained. Therefore, for example, it can be suitably used as a coil device for automobile.

Also, the wires do not have to be connected to the mounting part, thus even in case of coating a moisture proof material to the coil device, a stress acting on the wire connecting part is relieved, and a durability of the wire connecting part improves. Further, in image recognition of a solder fillet after mounting, the connecting part is suppressed from appearing in the image, and the image recognition becomes easy, thus an image recognition evaluation is stabilized.

Preferably, the other lead part of the first wire heading towards the coil part from the third terminal and the other lead part of the second wire heading towards the coil part from the fourth terminal are placed in close proximity at least between the inner face of the second collar part and the coil part. By constituting as such, the mode conversion property is further improved.

Preferably, the first collar part is provided with a first common guiding passage which guides the one lead part of the first wire and the one lead part of the second wire towards outside from the inner face of the first collar part. By constituting as such, the lead parts of both wires can be easily placed in close proximity between the coil part and the inner face of the collar part. The lead parts of the first wire and second wire extending out from the first common guiding passage respectively extend towards the wire connecting part of the first terminal and the wire connecting part of the second terminal, and the wires are connected there.

Preferably, the second collar part is provided with a second common guiding passage which guides the other lead part of the first wire and the other lead part of the second wire towards outside from the inner face of the second collar part. By constituting as such, the lead parts of both wires can be easily placed in close proximity between the coil part and the inner face of the collar part. The lead parts of the first wire and second wire extending out from the second common guiding passage respectively extend towards the wire connecting part of the third terminal and the wire connecting part of the fourth terminal, and the wires are connected there.

A first terminal guiding passage which guides the one lead part of the first wire towards outside from the inner face of the first collar part and a second terminal guiding passage which guides the one lead part of the second wire towards outside from the inner face of the first collar part may be formed to the first collar part, and the first terminal guiding passage and the second guiding passage may be in close proximity at the inner face of the first collar part. By constituting as such, the lead parts of both wires can be placed in close proximity between the inner face of the first collar part and the coil part, and in such case the mode conversion property improves as well.

A third terminal guiding passage which guides the other lead part of the first wire towards outside from the inner face of the second collar part and a fourth terminal guiding passage which guides the other lead part of the second wire towards outside from the inner face of the second collar part may be formed to the second collar part, and the third terminal guiding passage and the fourth guiding passage may be in close proximity at the inner face of the second collar part. By constituting as such, the lead parts of both wires can be placed in close proximity between the inner face of the collar part and the coil part, and in such case the mode conversion property improves as well.

Preferably, the coil device further has a board which extends between an opposite face of the mounting face of the first collar part and an opposite face of the mounting face of the second collar part. The board is preferably constituted by a magnetic material as similar to a magnetic core made from a coil and a core part, but the board does not necessarily have to be a magnetic material. By constituting the board by a magnetic material, a closed magnetic path circuit can be formed together with the magnetic core, and a magnetic property of the coil device improves.

The board may be provided with a board first common guiding passage which guides the one lead part of the first wire and the one lead part of the second wire together towards outside from the inner face of the first collar part. Also, the board may be provided with a board second common guiding passage which guides the other lead part of the first wire and the other lead part of the second wire together towards outside from the inner face of the second collar part. By forming the guiding passages to the board, a guiding passage does not have to be formed to the guiding passage, and a volume reduction of the magnetic core is suppressed, thus the magnetic property can be improved.

A length of the one lead part of the first wire from the coil part to the first terminal and a length of the one lead part of the second wire from the coil part to the second terminal may be about the same, or may be different. Preferably, a number of windings of the first wire around the coil part and a number of windings of the second wire around the coil part are the same. By constituting as such, the mode conversion property can be further improved.

Preferably, a winding density of the first wire and a winding density of the second wire decrease in the middle of the core and form an exposed area in which a surface of the core is exposed, and the crossing part is formed to the exposed area. By constituting as such, the mode conversion property further improves.

In the coil device of the present invention, even in case wire connecting parts of the first terminal, second terminal, third terminal, and fourth terminal are placed other than the mounting face of the first collar part and the second collar part, the mode conversion property can be improved. Particularly, in case the coil device has the board, the mode conversion property can be improved.

### BRIEF DESCRIPTION OF DRAWINGS

FIG. 1 is a perspective view of the coil device according to an embodiment of the present invention.

FIG. 2 is a plan view of the coil device shown in FIG. 1.

FIG. 3 is an exploded perspective view of the coil device shown in FIG. 1.

FIG. 4A is a perspective view of the coil device according to other embodiment of the present invention.

FIG. 4B is a perspective view of the coil device according to further other embodiment of the present invention.

FIG. 4C is a perspective view of the coil device according to further other embodiment of the present invention.

FIG. 4D is a perspective view of the coil device according to a comparative example of the present invention.

FIG. 5 is a graph showing an effect of the coil device according to an example of the present invention.

### DETAILED DESCRIPTION OF THE INVENTION

Hereinafter, the present invention will be described based on an embodiment.

### First Embodiment

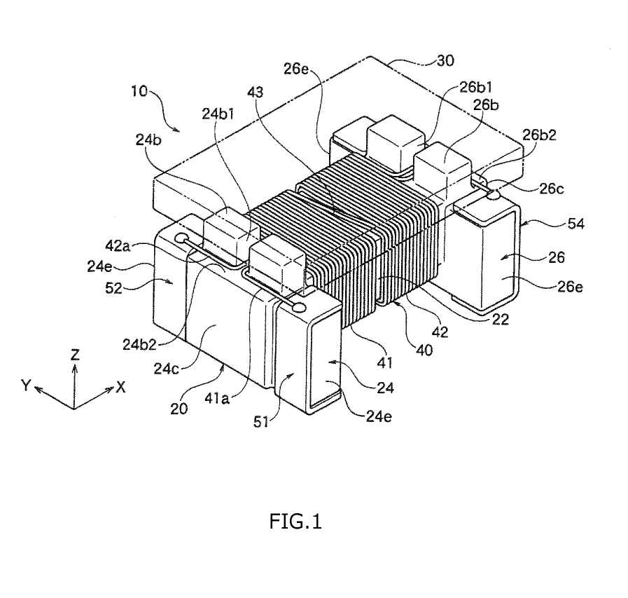

A coil device 10 according to an embodiment of the present invention shown in FIG. 1 is preferably used as a coil type common mode filter and the like, and the use thereof is not particularly limited. For example, it may be used as a balun, a dual inductor, and the like.

The coil device 10 has a drum core 20, a coil part 40 wound around a core 22 of the drum core 20, and a board 30 placed on upper part of the drum core 20. Note that, when explaining the coil device 10, X-axis direction is on a parallel plane with a mounting face where the coil device 10 is mounted and also X-axis direction is parallel to a coil axis of the core 22 of the drum core 20, Y-axis direction is on a parallel plane with a mounting face as similar to X-axis and is perpendicular to X-axis; and Z-axis direction is a normal direction to the mounting face.

The drum core 20 has the core 22 of rod shape and a pair of first collar part 24 and second collar part 26 as a pair of end part of the core provided to both ends of the core 22. An outer shape of the first collar part 24 is approximately rectangular parallelepiped shape, the first collar part 24 and the second collar part 26 are placed to be approximately parallel to each other taking predetermined space in X-axis direction between each other. The core 22 is connected to approximately center part of each faces of the pair of first and second collar parts 24 and 26 which are facing against each other, and the core 22 is integrally formed with the pair of first and second collar parts 24 and 26 as one body. A transverse cross section shape of the core 22 is rectangle shape in the present embodiment, but the cross section shape is not particularly limited and it may be a circular shape.

At an upper end part in Z-axis direction of the drum core 20, a board 30 is preferably adhered. The flat board 30 extends between an opposite face 24b of the mounting face 24a of the first collar 24 and an opposite face 26b of the mounting face 26a of the second collar 26, and the board 30 preferably connects with these opposite faces of the mounting face.

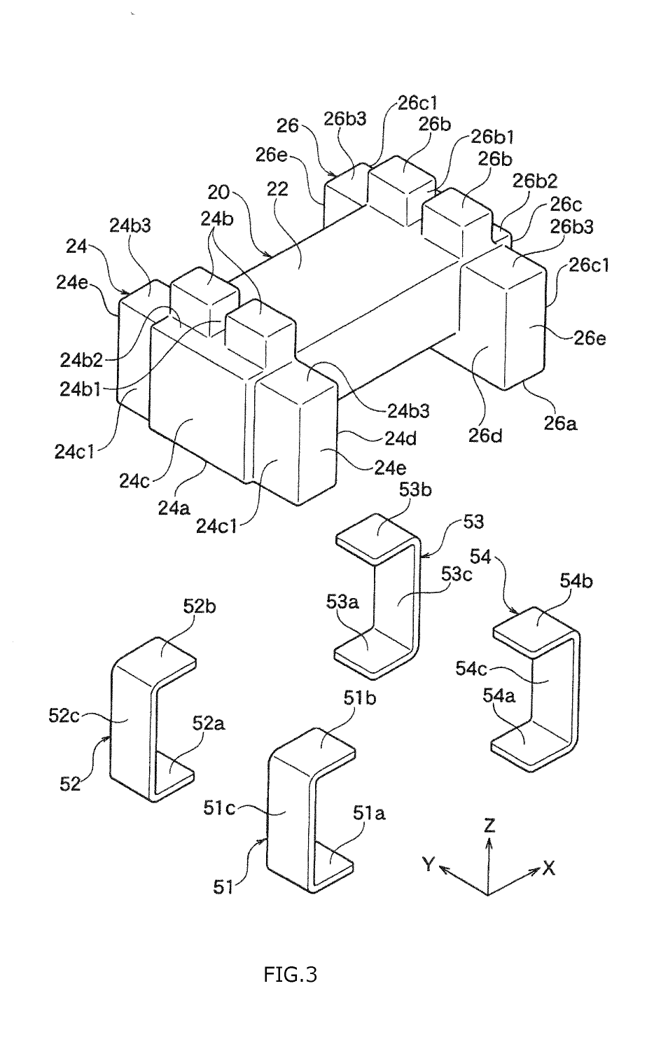

As shown in FIG. 3, in the present embodiment, the first collar 24 is constituted in a rectangular parallelepiped shape as a whole. The first collar part 24 has a mounting face 24a which is a lower face in Z-axis direction, the opposite face 24b which is opposite to the mounting face 24a, an outer end face 24c in X-axis direction, an inner face 24d facing towards the core 22, and a pair of side faces 24e and 24e which are positioned opposite to each other in Y-axis direction. At the center part in Y-axis direction of the opposite face 24b of the mounting face 24a, a first common guiding passage 24b1 of a groove shape is formed, which is opened in X-axis direction.

Also, at outer side in X-axis direction of the opposite face 24b of the mounting face 24a, a guiding face 24b2 is formed approximately on the same level in Z-axis direction of the first common guiding passage 24b1. Also, at both sides in Y-axis direction of the opposite face 24b of the mounting face 24a, a wire connection step face 24b3 is formed which is slightly lower in Z-axis direction with respect to the guiding step face 24b2.

The depth of the first common guiding passage 24b1 in Z-axis direction only needs to be a depth so that the one lead part 41a of the first wire 41 and the one lead part 42a of the second wire 42 which are constituting the coil part 40 shown in FIG. 1 can pass through the first common guiding passage 24b1 without being interfered by the board 30. Also, a width in Y-axis direction of the first common guiding passage 24b1 only needs to be a width so that the one lead part 41a of the first wire 41 and the one lead part 42a of the second wire 42 can pass through the first common guiding passage 24b1 without being interfered by the board 30. Note that, a position where the first common guiding passage 24b1 is formed does not necessarily have to be at a center in Y-axis direction of the opposite face 24b of the mounting face 24a, and it may be shifted towards either one of the side faces 24e.

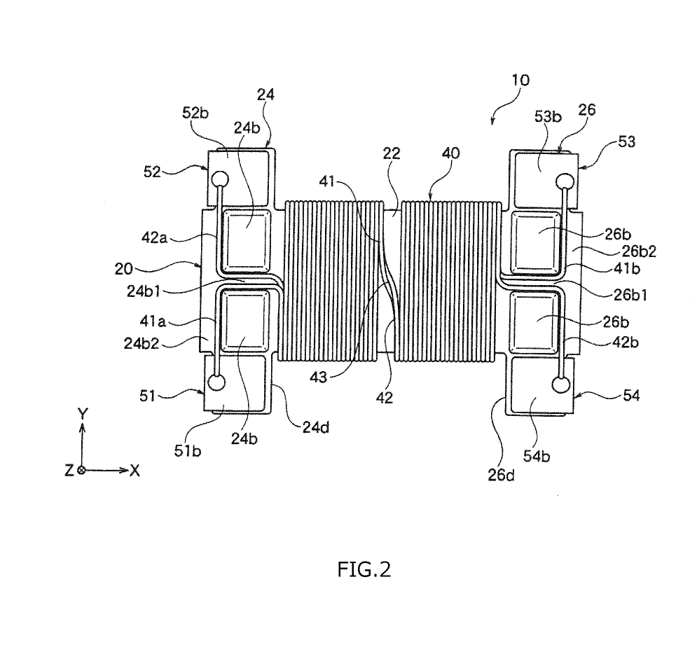

A width in X-axis direction of the guiding face 24b2 dented in X-axis direction from the outer end face 24c is not particularly limited as long as each of lead parts 41a and 42a can be guided to outside in Y-axis direction. As shown in FIG. 2, the lead parts 41a and 42a together extend out from the coil part 40 to the inner face 24d of the first collar part 24, and extend to outside in X-axis direction by together passing through the first common guiding passage 24b1. Then, the lead parts 41a and 42a respectively extend to opposite direction with each other towards outside in Y-axis direction of the guiding face 24b2.

As shown in FIG. 3, at both sides in Y-axis direction of the outer end face 24c, a terminal installation face 24c1 is formed to each side which is dented towards the inner side in X-axis direction (a center side of the core 20) than the outer end face 24c. A width of each terminal installation face 24c1 is about the same as the width in Y-axis direction of the wire connection step face. An inner face of a terminal main body 51c of the first terminal 51 and an inner face of a terminal main body 52c of the second terminal 52 are respectively installed to each terminal installation face 24c, and if needed, it is adhered.

The terminal installation face 24c1 is dented towards inside in X-axis direction with respect to the outer end face 24c preferably in a level about the same as the thickness of the first terminal 51 or the second terminal 52. Also, the wire connection step face 24b3 is lower in Z-axis direction with respect to the guiding face 24b2, and it is preferably lower in a level about the same as the thickness of the first terminal 51 or the second terminal 52.

The first terminal 51 is constituted by a conductive board material such as metal and the like. In the first terminal 51, a bended part which becomes the mounting part 51a is integrally formed to the terminal main body 51c at a lower side in Z-axis direction of the rectangle shaped terminal main body 51c; and a bended part which becomes the wire connection part 51b is integrally formed to the terminal main body 51c at an upper side in Z-axis direction of the terminal main body 51c. The mounting part 51a is constituted to be about the same shape as the wire connection part 51b, and it is installed by attaching to the mounting face 24a of the first collar part 24. The wire connection part 51b is installed by attaching to the wire connection step face 24b3.

The wire connection step face 24b3 and the mounting face 24a positioned opposite thereof are held by the wire connection part 51b and the mounting part 51a, thereby the terminal main body 51c of the first terminal 51 is installed to the terminal installation face 24c1. Thus, the first terminal 51 is easily installed to the first collar part 24, and an installation strength improves.

As similar to the first terminal 51, the second terminal 52 is also constituted by a conductive board material such as metal and the like. In the second terminal 52, a bended part which becomes the mounting part 52a is integrally formed to the terminal main body 52c at a lower side in Z-axis direction of the rectangle shaped terminal main body 52c; and a bended part which becomes the wire connection part 52b is integrally formed to the terminal main body 52c at an upper side in Z-axis direction of the terminal main body 52c. The mounting part 52a is constituted to be about the same shape as the wire connection part 52b and it is installed by attaching to the mounting face 24a of the first collar part 24. The wire connection part 52b is installed by attaching to the wire connection step face 24b3.

The wire connection step face 24b3 and the mounting face 24a positioned opposite thereof are held by the wire connection part 52b and the mounting part 52a, thereby the terminal main body 52c of the second terminal 52 is installed to the terminal installation face 24c1. Thus, the second terminal 52 is easily installed to the first collar part 24, and an installation strength improves.

In the present embodiment, the second collar part 26 has similar constitution as the first collar part 24, but it does not necessarily have to be the same. In the present embodiment, the second collar part 26 is constituted in a rectangular parallelepiped shape as a whole, and the second collar part 26 has the mounting face 26a which is the lower face in Z-axis direction, and an opposite face 26b of the mounting face 26a, an outer end face 26c in X-axis direction, an inner face 26d facing towards the direction of the core 22, and a pair of side faces 26e and 26e positioned opposite to each other in Y-axis direction. At a center part in Y-axis direction of the opposite face 26b of the mounting face 26a, a second guiding passage 26b1 of a groove shape is formed, which is opened in X-axis direction.

Also, at outer side in X-axis direction of the opposite face 26b of the mounting face 26a, a guiding face 26b2 is formed approximately on the same level in Z-axis direction of the second common guiding passage 26b1. Also, at both sides in Y-axis direction of the opposite face 26b of the mounting face 26a, a wire connection step face 26b3 is formed which is slightly lower in Z-axis direction with respect to the guiding step face 26b2.

The depth of the second common guiding passage 26b1 in Z-axis direction only needs to be a depth so that the other lead part 41b of the first wire 41 and the other lead part 42b of the second wire 42 which are constituting the coil part 40 shown in FIG. 2 can pass through the second common guiding passage 26b1 without being interfered by the board 30 shown in FIG. 1. Also, a width in Y-axis direction of the second common guiding passage 26b1 only needs to be a width so that the other lead part 41b of the first wire 41 and the other lead part 42b of the second wire 42 can pass through the second common guiding passage 26b1 without being interfered by the board 30. Note that, a position where the second common guiding passage 26b1 is formed does not necessarily have to be at a center in Y-axis direction of the opposite face 26b of the mounting face 26a, and it may be shifted towards either one of the side faces 26e.

As shown in FIG. 3, a width in X-axis direction of the guiding face 26b2 dented in X-axis direction from the outer end face 26c is not particularly limited as long as each of lead parts 41b and 42b shown in FIG. 2 can be guided to outside in Y-axis direction. The lead parts 41b and 42b together extend out from the coil part 40 to the inner face 26d of the second collar part 26, and extend to outside in X-axis direction by together passing through the second common guiding passage 26b1. Then, the lead parts 41b and 42b respectively extend in opposite direction with respect to each other towards outside in Y-axis direction of the guiding face 26b2.

As shown in FIG. 3, at both sides in Y-axis direction of the outer end face 26c, a terminal installation face 26c1 is formed on each side which is dented towards the inner side in X-axis direction (a center side of the core 20) than the outer end face 26c. A width of each terminal installation face 26c1 is about the same as the width in Y-axis direction of the wire connection step face 26b3. An inner face of a terminal main body 53c of the third terminal 53 and an inner face of a terminal main body 54c of the fourth terminal 54 are respectively installed to each terminal installation face 26c1, and if needed, it is adhered.

The terminal installation face 26c1 is dented towards inside in X-axis direction with respect to the outer end face 26c preferably in a level about the same as the thickness of the third terminal 53 or the fourth terminal 54. Also, the wire connection step face 26b3 is lower in Z-axis direction with respect to the guiding face 26b2, and it is preferably lower in a level about the same as the thickness of the third terminal 53 or the fourth terminal 54.

The third terminal 53 is constituted by a conductive board material such as metal and the like. In the third terminal 53, a bended part which becomes the mounting part 53a is integrally formed to the terminal main body 53c at a lower side in Z-axis direction of the rectangle shaped terminal main body 53c; and a bended part which becomes the wire connection part 53b is integrally formed to the terminal main body 53c at an upper side in Z-axis direction of the terminal main body 53c. The mounting part 53a is constituted to be about the same shape as the wire connection part 53b, and it is installed by attaching to the mounting face 26a of the second collar part 26. The wire connection part 53b is installed by attaching to the wire connection step face 26b3.

The wire connection step face 26b3 and the mounting face 26a positioned opposite thereof are held by the wire connection part 53b and the mounting part 53a, thereby the terminal main body 53c of the third terminal 53 is installed to the terminal installation face 26c1. Thus, the third terminal 53 is easily installed to the second collar part 26, and an installation strength improves.

The fourth terminal 54 is constituted by a conductive board material such as metal and the like as similar to the first terminal 51, the second terminal 52, and the third terminal 53. In the fourth terminal 54, a bended part which becomes the mounting part 54a is integrally formed to the terminal main body 54c at a lower side in Z-axis direction of the rectangle shaped terminal main body 54c; and a bended part which becomes the wire connection part 54b is integrally formed to the terminal main body 54c at an upper side in Z-axis direction of the terminal main body 54c. The mounting part 54a is constituted to be about the same shape as the wire connection part 54b, and it is installed by attaching to the mounting face 26a of the second collar part 26. The wire connection part 54b is installed by attaching to the wire connection step face 26b3.

The wire connection step face 26b3 and the mounting face 26a positioned opposite thereof are held by the wire connection part 54b and the mounting part 54a, thereby the terminal main body 54c of the fourth terminal 54 is installed to the terminal installation face 26c1. Thus, the fourth terminal 54 is easily installed to the second collar part 26, and an installation strength improves.

As shown in FIG. 2, a tip part of the one lead part 41a of the first wire 41 is attached to the wire connection part 51b of the first terminal 51, and a tip part of the one lead part 42a of the second wire 42 is attached to the wire connection part 52b of the second terminal 52. Also, a tip part of the other lead part 41b of the first wire 41 is attached to the wire connection part 53b of the third terminal 53, and a tip part of the other lead part 42b of the second wire 42 is attached to the wire connection part 54b of the fourth terminal 54. As a means for attaching these, it is not particularly limited, and a solder, a thermal compression, a laser welding, and the like may be mentioned.

As shown in FIG. 1, the coil part 40 is formed at the core 22 of the drum core 20. In the present embodiment, the coil part 40 is constituted by two wires 41 and 42. The wires 41 and 42 are for example constituted by a coated conductive wire, and have a constitution in which the core made of a good conductor being coated with an insulating coating film. For example, the wires 41 and 42 are wound around the core 22 in two layer structure. In the present embodiment, each of the wires 41 and 42 has the same transverse cross section area of the conductor part.

In the present embodiment, as shown in FIG. 2, a winding density of the first wire 41 and a winding density of the second wire 42 decrease in the middle of the core 22 in X-axis direction and forms an exposed area in which a surface of the core is exposed, and at the exposed area, a crossing part 43 is present where the first wire 41 and the second wire 42 cross with each other.

In the present embodiment, the first wire 41 and the second wire 42 form a usual bifilar-wound around the core 22, and the crossing part 43 is formed at a predetermined position along an axis direction of the core 22.

For a production of the coil device 10, first, the drum core 20 provided with the terminals 51 to 54, the board 30, and the wires 41 and 42 are prepared. The drum core 20 is constituted by a magnetic material, and for example it is produced by molding and sintering magnetic powder constituted for example by a magnetic material having relatively high magnetic permeability such as Ni—Zn based ferrite, Mn—Zn based ferrite, magnetic metal, or the like. Preferably, the board 30 is constituted by a magnetic material which may be same or different from the drum core 20, but the board 30 does not necessarily have to be constituted by a magnetic material.

The first to fourth terminals 51 to 54 made of metal are fixed at a predetermined position of the collar parts 24 and 26 of the drum core 20 by adhesion and the like. Note that, the terminals 51 to 54 may be provided to the collar part 24 by forming a conductive film to the drum core 20 by printing, plating, and the like, then by firing the conductive film.

As the wires 41 to 42, for example, the core material made of a good conductor such as copper (Cu) and the like may be coated by an insulation material such as imide modified polyurethane and the like, then an outer most face may be coated by a thin resin film such as polyester and the like, thereby this may be used as the wires 41 to 42. The prepared drum core 20 provided with the terminals 51 to 54 and the wires 41 and 42 are set to a coil winding machine, and the wires 41 and 42 are wound around the core 22 of the drum core 20 in predetermined sequence.

In the present embodiment, in a first section, the bifilar-wound of the first wire 41 and the second wire 42 is formed, and then in a second section, the bifilar-wound is formed by reversing the layer order of the first wire 41 and the second wire 42. The lead parts 41a, 42a, 41b, and 42b which are wire ends of the wound wires 41 and 42 are fixed to the wire connection parts 51b to 54b of the predetermined terminals 51 to 54 shown in FIG. 2 by a silver solder, a thermal compression, a laser bonding, or the like. Note that, a method of winding the wires 41 and 42 is not particularly limited. Also, the winding may start from the second section which is closer to the second collar part 26 then to the first section direction which is closer to the first collar part 24.

After winding the wires 41 and 42 around the core 22, the board 30 is attached to the opposite faces 24b and 26b of the mounting faces 24a and 26a of the collar parts 24 and 26. A means for attaching is not particularly limited, and for example a method of adhering may be mentioned.

In the coil device 10 according to the present embodiment, the one lead part 41a of the first wire 41 heading towards the coil part 40 from the first terminal 51 and the one lead part 42a of the second wire 42 heading towards the coil part 40 from the second terminal 52 are placed in close proximity at least between the inner face of the first collar part 24 and the coil part 40. Note that, in the present embodiment, the two lead parts placed in close proximity means that each of the lead parts are in contact or in case it is away from each other the distance between the two is 1.6 mm or less.

Also, the other lead part 41b of the first wire 41 heading towards the coil part 40 from the third terminal 53 and the other lead part 42b heading towards the coil part 40 from the fourth terminal 54 are placed in close proximity at least between the inner face of the second collar part 26 and the coil part 40.

That is, as shown in FIG. 2, the one lead part 41a of the first wire 41 and the one lead part 42a of the second wire 42 extending from the coil part 40 together extend out from the coil part 40 through the inner face 24d of the first collar part 24, and guided towards the first common guiding passage 24b1. The lead part 41a and the lead part 42a extend away from each other to the opposite direction in Y-axis direction at outside in X-axis direction of the first common guiding passage 24b1.

Similarly, the other lead part 41b of the first wire 41 and the other lead part 42b of the second wire 42 extending from the coil part 40 together extend out from the coil part 40 through the inner face 26d of the second collar part 26, and guided towards the second common guiding passage 26b1. The lead part 41b and the lead part 42b extend away from each other to the opposite direction in Y-axis direction at outside in X-axis direction of the second common guiding passage 26b1. Further in the present embodiment, the crossing part 43 is formed at a predetermined position along the axis direction of the core 22.

The present inventors have found that by constituting as such, when the coil device 10 is used as the common mode filter, the mode conversion property improves.

As an index regarding the noise property and signal quality of the common mode filter, the mode conversion property is used. In case the mode conversion property is good, a differential signal is not converted to a common mode, thus this indicates that a property as the common mode filter is good. Particularly recently, the data transfer rate has improved, and an excellent mode conversion property at a transfer rate of 100 Mbps or more is demanded. Particularly, as the common mode filter used for Automotive Ethernet™ and the like, higher performance is demanded. According to the coil device 10 of the present embodiment, the common mode filter capable of complying with such demands can be attained.

According to the coil device 10 of the present embodiment, the wire connection parts 51b to 54b to which the wire 41 or 42 shown in FIG. 2 is connected are not connected to the mounting faces 24a and 26a of the collar parts 24 or 26, but are placed to the sides of the opposite faces 24b and 26b of the mounting faces 24a and 24b as shown in FIG. 3. Even in such case, the mode conversion property improves. Therefore, the wire connection parts 51b to 54b receives less adverse effect which is caused by heat of solder during mounting applied to the mounting parts 51a to 54a of the terminals 51 to 54, thus the heat resistance wire does not necessarily have to be used as the wires 41 and 42 constituting the coil parts 40.

Also, since there is no need to connect the wires 41 and 42 to the mounting parts 51a to 54a, for example the metal terminals 51 to 54 can be installed to the collar parts 24 and 26, thus a structure having strong thermal shock resistance can be attained. Therefore, for example it can be suitably used as the coil device 20 for automobile.

Also, since there is no need to connect the wires 41 and 42 to the mounting parts 51a to 54a, even in case the moisture proof material is coated to the coil device 10, the stress acting on the wire connection parts 51b to 54b of the wires 41 and 42 is relieved, thus the durability of the wire connection parts 51b to 54b of the wires 41 and 42 is improved. Further, in image recognition of a solder fillet after mounting, the wire connecting part is suppressed from appearing in the image, and the image recognition becomes easy, thus an image recognition evaluation is stabilized.

Also, in the present embodiment, as shown in FIG. 2, the first collar part 24 is provided with the first common guiding passage 24b1 which guides the one lead part 41a of the first wire 41 and the one lead part 42a of the wire 42 together towards outside from the inner face 24d of the first collar part 24. By constituting as such, the lead parts 41a and 42a of the wires 41 and 42 can be placed in close proximity to each other between the inner face 24d of the collar part 24 and the coil part 40.

Also, similarly, the second collar part 26 is provided with the second common guiding passage 26b1 which guides the other lead part 41b of the first wire 41 and the other lead part 42b of the second wire 42 together towards outside from the inner face 26d of the second collar part 26. By constituting as such, the lead parts 41b and 42b of the wires 41 and 42 can be easily placed in close proximity to each other between the inner face 26d of the second collar part 26 and the coil part 40. The lead parts 41b and 42b of the first wire 41 and the second wire 42 which extend from the second common guiding passage 26b1 further extend towards the wire connection part 53b of the third terminal 53 and the wire connection part 54b of the fourth terminal 54 respectively, and then the wire connection treatment is carried out.

Further, the present embodiment further has the board 30 which extends between the opposite face 24b of the mounting face 24a of the first collar part 24 and the opposite face 26b of the mounting face 26a of the second collar part 26. The board 30 may be constituted by a magnetic material, thereby a closed magnetic path circuit can be formed together with the drum core 20 which is constituted by a magnetic material, and a magnetic property of the coil device 20 improves.

Further in the present embodiment, the wire length of the one lead part 41a of the first wire 41 from the coil part 40 to the wire connection part 51b of the first terminal 51 and the wire length of the one lead part 42a of the second wire 42 from the coil part 40 to the wire connection part 52b of the second terminal 52 are preferably about the same, but these may be different. Also, preferably, the number of windings of the first wire 41 and the number of winding of the second wire 42 around the coil 40 are the same. By constituting as such, the mode conversion property further improves.

In the coil device 10 of the present embodiment, the wire connection parts 51b to 54b of the wires of the first terminal 51, second terminal 52, third terminal 53, and fourth terminal 54 are not positioned on the mounting face 24a of the first collar part 24 and the mounting face 26a of the second collar part 26, but are positioned near the bonding part of the board 30 at the sides of the opposite faces 24b and 26b of the mounting faces 24a and 26a.

In the present embodiment, the lead part 41a of the wire 41 heading towards the coil part 40 from the first terminal 51 and the lead part 42a of the wire 42 heading towards the coil part 40 from the second terminal 52 are placed in close proximity at least between the inner face 24d of the collar part 24 and the coil part 40. Further, the crossing part 43 is formed at the predetermined position along the core axis direction of the core 22. By constituting as such, the mode conversion property can be improved. Also, in the present embodiment, the lead part 41b of the wire 41 heading towards the coil part 40 from the third terminal 53 and the lead part 42b of the wire 42 heading towards the coil part 40 from the fourth terminal 54 are placed in close proximity at least between the inner face 26d of the second collar part 26 and the coil part 40. Further, the crossing part 43 is formed at the predetermined position along the core axis direction of the core 22. By constituting as such, the mode conversion property is further improved.

Also, in the present embodiment, as shown in FIG. 2, the lead peats 41a and 42a (41a and 42b) extend together between the coil part 40 and the inner face 24d (26d) of the first collar part 24 (the second collar part 26), and then passes through the first common guiding passage 24b1 (26b1) together. Then, the lead parts 41a and 42a (41b and 42b) extend towards outside in X-axis direction, and extend in opposite direction against each other towards outside in Y-axis direction on the guiding face 24b2 (26b2). Thus, lead parts 41a and 42a (41b and 42b) of the wire 41 (42) do not expose to outside of the coil device 10, hence the lead parts 41a and 42a (41b and 42b) are unlikely to contact other members and cause damage while handling the coil device.

Further, in the present embodiment, as shown in FIG. 3, by fitting the terminals 51 to 54 to the collar parts 24 and 26, the thermal shock resistance of the coil device 10 can be improved. Further, by providing a projection part and a dented part for fitting the terminals 51 to 54 and the collar parts 24 and 26 respectively, the position of the terminals 51 to 54 is stabilized; hence there is a merit from the point of the production.

### Second Embodiment

The coil device according to the second embodiment of the present invention is same as the aforementioned first embodiment other than the constitutions mentioned in below, and the same effect is attained, thus the overlapping section is omitted from describing. Also, in the figures, the same members as the first embodiment are given with the same numerical references.

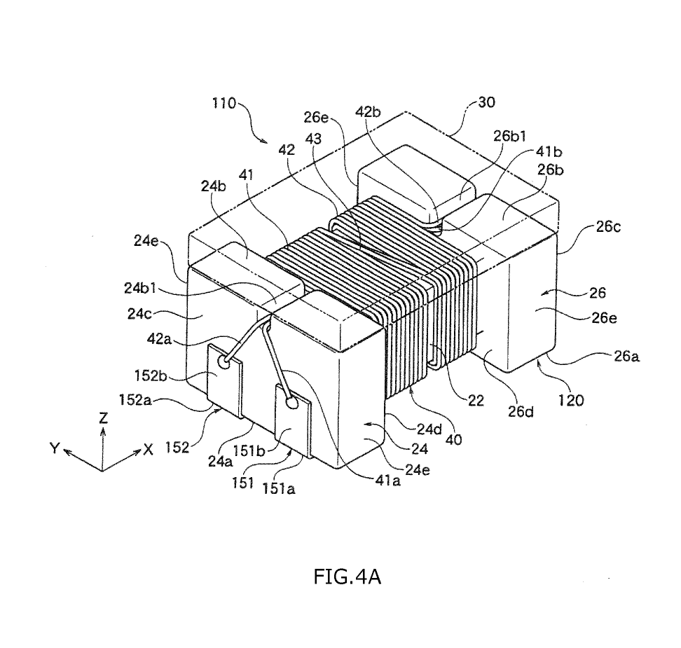

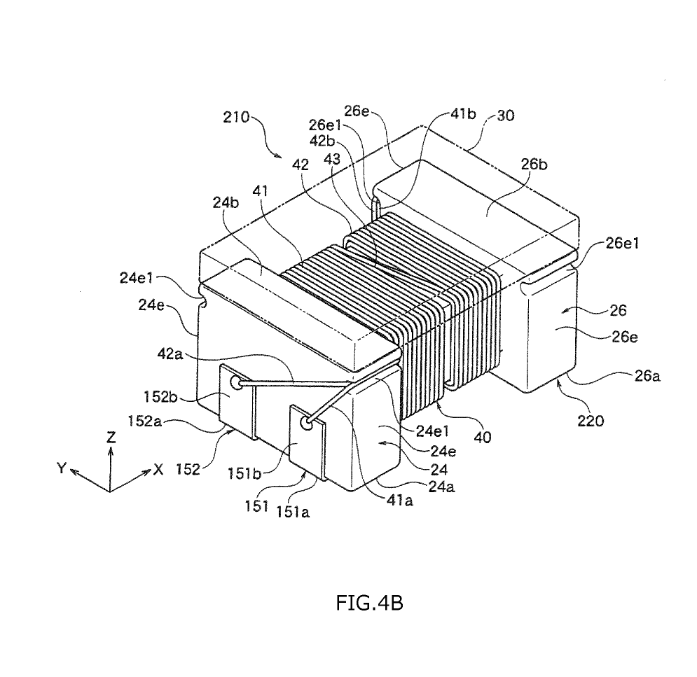

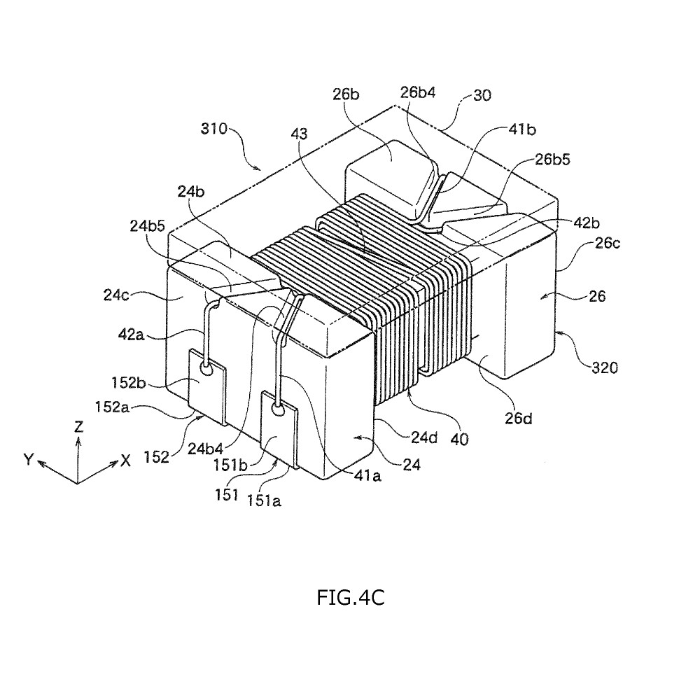

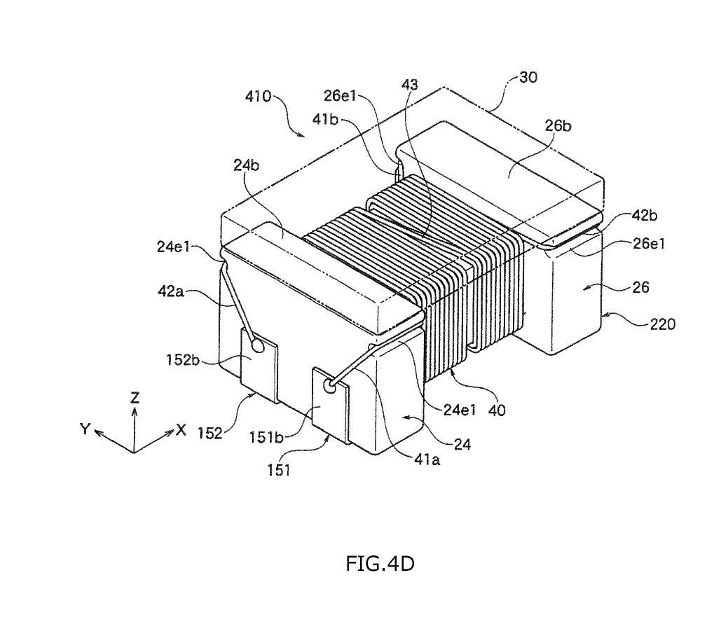

As shown in FIG. 4A, a coil device 110 of this embodiment has a drum core 120. An area of the opposite face 24b of the mounting face of the first collar part 24 of the drum core 120 is about the same as X-Y cross section of the first collar part 24, and an bonding area with the board 30 is relatively larger compared to the coil device 10 of the embodiment shown in FIG. 1.

At approximately center part in Y-axis direction of the opposite face 24b of the mounting face 24a, the first common guiding passage 24b1 is formed which is opened from the inner face 24d of the collar part 24 to the outer end face 24c. The lead part 41a of the first wire and the lead part 42a of the second wire which are guided from the coil part 40 to the first common guiding passage 24b1 extend out to separate directions at an end part of the first common guiding passage 24b1. A tip part of the lead part 41a of the first wire which extended out from the first common guiding passage 24b1 then heads towards a wire connection part 151b of a first terminal 151, and the wire connection treatment such as soldering and the like is carried out. Also, a tip part of the lead part 42a of the second wire which extended out from the first common guiding passage 24b1 then heads towards a wire connection part 152b of the second terminal 152, and the wire connection treatment such as soldering and the like is carried out.

In the present embodiment, the first terminal 151 and the second terminal 152 have the same shape, and each of them has the mounting parts 151a and 152a, and the wire connection parts 151b and 152b. These terminals 151 and 152 are for example formed by a metal board of which the cross section is L shaped, and each of them has the mounting parts 151a and 152a, and the wire connection parts 151b and 152b.

The mounting parts 151a and 152a of the terminals 151 and 152 are adhered to the mounting face 24a positioned near the outer end face 24c of the collar part 24 and away from each other taking predetermined distance in Y-axis direction. Also, the wire connection parts 151b and 152b of the terminals 151 and 152 are adhered to the outer end face 24c positioned near the mounting face 24a of the collar part 24 and away from each other taking predetermined distance in Y-axis direction.

Note that, although it is not shown in FIG. 4A, the third terminal and the fourth terminal are in similar relation as in case of the first terminal 151 and the second terminal 152, and have same shape and respectively has the mounting part and the wire connection part.

The mounting parts of the third terminal and the fourth terminal are adhered to the mounting face 26a positioned near the outer end face 26c of the collar part 26 and away from each other taking predetermined distance in Y-axis direction. Also, the wire connection parts of the third terminal and the fourth terminals are adhered to the outer end face 26c positioned near the mounting face 26a of the collar part 26 and away from each other taking predetermined distance in Y-axis direction.

In the present embodiment, the second collar part 26 has similar constitution as the first collar part 24, and at approximately center part in Y-axis direction of the opposite face 26b of the mounting face 26a, the second common guiding passage 26b1 is formed which is opened from the inner face 26d of the collar part 26 to the outer end face 26c. The lead part 41b of the first wire and the lead part 42b of the second wire which are guided to the second common guiding passage 26b1 from the coil part 40 extend out in separate directions from the end part of the second common guiding passage 26b1. This end part of the second common guiding passage 26b1 is formed between the edge of the outer end face 26c.

The tip part of the lead part 41b of the first wire which extended out heads towards the wire connection part of the third terminal and then the wire connection treatment is carried out by soldering and the like. Also, the tip part of the lead part 42b of the second wire which extended out heads towards the wire connection part of the fourth terminal and then the wire connection treatment is carried out.

In the coil device 110 of the present embodiment, the wire connection parts (151b and 152b are only shown in the figure) of the wires 41 and 42 are not positioned on the mounting face 24a of the first collar part 24 and the mounting face 26a of the second collar part 26, but are positioned to the outer end faces 24c and 26c of the collar parts 24 and 26.

In the present embodiment, the lead parts 41a of the wire 41 heading towards the coil part 40 from the first terminal 151 and the lead part 42a of the wire 42 heading towards the coil part 40 from the second terminal 52 are placed in close proximity at least between the inner face 24d of the collar part 24 and the coil 40. Further, the crossing part 43 is formed at a predetermined position along the core axis direction of the core 22. By constituting as such, the mode conversion property is improved. Also, in the present embodiment, the lead part 41b of the wire heading towards the coil part 40 from the third terminal and the lead part 42b of the wire 42 heading towards the coil part 40 from the fourth terminal are placed in close proximity at least between the inner face 26d of the collar part 26 and the coil part 40. Further, the crossing part 43 is formed at the predetermined position along the core axis direction of the core 22. By constituting as such, the mode conversion property is improved.

### Third Embodiment

The coil device according to the third embodiment of the present invention is same as the aforementioned first and second embodiments other than the constitutions mentioned in below, and the same effect is attained, thus the overlapping section is omitted from describing. Also, in the figures, the same members as the first and second embodiments are given with the same numerical references.

As shown in FIG. 4B, a coil device 210 of this embodiment has a drum core 220. An area of the opposite face 24b of the mounting face of the first collar part 24 of the drum core 220 is about the same as X-Y cross section of the first collar part 24, and an bonding area with the board 30 is larger compared to the coil device 110 of the embodiment shown in FIG. 4A.

The entire face of the opposite face 24b and 26b of the mounting face 24a and 26a are attached with the board 30. In the present embodiment, a first common guiding passage 24e1 of a groove shape formed to each of both side faces 24e of the first collar part 24 positioned near the opposite face 24b of the mounting face. The lead part 41a of the first wire and the lead part 42a of the second wire which are together guided to either one of the first common guiding passage 24e1 from the coil part 40 and extend out to separate direction at an end part of the first common guiding passage 24e1. This end part of the first common guiding passage 24e1 is formed to the edge of the outer end face 24c.

The tip part of the lead part 41a of the first wire which extended out heads towards the wire connection part 151b of the first terminal 151, and then the wire connection treatment such as soldering and the like is carried out. The tip part of the lead part 42a of the second wire which extended out heads towards the wire connection part 152b of the first terminal 152, and then the wire connection treatment such as soldering and the like is carried out.

In the present embodiment, the first terminal 151 and the second terminal 152 are the same as the terminals 151 and 152 shown in FIG. 4A. The mounting parts 151a and 152a of the terminals 151 and 152 are adhered to the mounting face 24a positioned near the outer end face 24c of the collar part 24, and separate from each other in predetermined distance in Y-axis direction. Also, the wire connection parts 151b and 152b of the terminals 151 and 152 are adhered to the outer end face 24c positioned near the mounting face 24a of the collar part 24, and separate from each other in predetermined distance in Y-axis direction.

Note that, although it is not shown in FIG. 4B, the third terminal and the fourth terminal are in similar relation as in case of the first terminal 151 and the second terminal 152, and have same shape and each of them have the mounting part and the wire connection part.

The mounting part of the third and fourth terminals are adhered to the mounting face 26a positioned near the outer end face 26c of the collar part 26, and separate from each other in predetermined distance in Y-axis direction. Also, the wire connection part of the third and fourth terminals are adhered to the outer end face 26c positioned near the mounting face 26a of the collar part 26, and separate from each other in predetermined distance in Y-axis direction.

In the present embodiment, a second common guiding passage 26e1 of a groove shape is formed to each of both side faces 26e of the second collar part 26 having similar constitution as the first collar part 24 and positioned near the opposite face 26b of the mounting face. The lead part 41b of the first wire and the lead part 42b of the second wire which are together guided to either one of the second common guiding passage 26e1 from the coil part 40 extend out to separate directions at an end part of the second common guiding passage 26e1. This end part of the second common guiding passage 26e1 is formed to the edge of the outer end face 26c.

Note that, in the present embodiment, the first common guiding passage 24e1 of which the lead parts 41a and 42a of the wires are guided together, and the second common guiding passage 26e1 of which the lead parts 41b and 42b of the wires are guided together are preferably positioned in opposite direction in Y-axis direction.

The tip part of the lead part 41b of the first wire which extended out heads towards the wire connection part of the third terminal, and then the wire connection treatment such as soldering and the like is carried out. The tip part of the lead part 42b of the second wire which extended out heads towards the fourth terminal, and then the wire connection treatment such as soldering and the like is carried out.

In the coil device 210 of the present embodiment, the wire connection parts (151b and 152b are only shown in the figure) of the wires 41 and 42 are not positioned to the mounting face 24a of the first collar part 24 and the mounting face 26a of the second collar part 26, but are positioned to the outer end faces 24c and 26c of the collar parts 24 and 26.

In the present embodiment, the lead part 41a of the wire 41 heading towards the coil part 40 from the first terminal 151 and the lead part 42a of the wire 42 heading towards the coil part 40 from the second terminal 152 are placed in close proximity at least between the inner face 24d of the collar part 24 and the coil part 40. Further, the crossing part 43 is formed at the predetermined position along the core axis direction of the core 22. By constituting as such, the mode conversion property is improved. Also, in the present embodiment, the lead part 41b of the wire 41 heading towards the coil part 40 from the third terminal and the lead part 42b of the wire 42 heading towards the coil part 40 from the fourth terminal are placed in close proximity at least between the inner face 26d of the collar part 26 and the coil part 40. Further, the crossing part 43 is formed at the predetermined position along the core axis direction of the core 22. By constituting as such, the mode conversion property is improved.

Further, in the present embodiment, the first common guiding passage 24e1 of a groove shape is formed to both side faces 24e (26e) of the first collar part 24 (the second collar part 26) positioned near the opposite face 24b of the mounting face. Thus, the bonding area between the board 30 and the collar part 24 (26) can be made larger. Hence, an inductance of the coil device 210 can improve.

### Fourth Embodiment

The coil device according to the fourth embodiment of the present invention is same as the aforementioned first to third embodiments other than the constitutions mentioned in below, and the same effect is attained, thus the overlapping section is omitted from describing. Also, in the figures, the same members as the first to third embodiments are given with the same numerical references.

As shown in FIG. 4C, the coil device 310 of this embodiment has a drum core 320. An area of the opposite face 24b of the mounting face of the first collar part 24 of the drum core 320 is about the same as X-Y cross section of the first collar part 24, and an bonding area with the board 30 is larger compared to the coil device 10 of the embodiment shown in FIG. 1.

A first terminal guiding passage 24b4 is formed at the center part of an edge along Y-axis direction formed between the opposite face 24b of the mounting face and the inner face 24d of the first collar part 24. The first terminal guiding passage 24b4 is formed in an angle on the opposite mounting face 24b of the mounting face from the edge of the inner face 24d of the first collar part 24 towards the edge of the outer end face 24c where the first terminal 151 is provided. Also, a second terminal guiding passage 24b5 is formed at the center part of an edge along Y-axis direction formed between the opposite face 24b of the mounting face and the inner face 24d of the first collar part 24. The second terminal guiding passage 24b5 is formed in an angle on the opposite mounting face 24b of the mounting face from the edge of the inner face 24d of the first collar part 24 towards the edge of the outer end face 24c where the second terminal 152 is provided. These passages 24b4 and 24b5 intersect at the center part of the edge along Y-axis direction formed between the opposite face 24b of the mounting face and the inner face 24d of the first collar part 24, and are separated at an edge formed between the opposite face 24b of the mounting face and the outer end face 24c.

The lead part 41a of the first wire guided to the first terminal passage 24b4 from the coil part 40 extends downwards in Z-axis direction along the outer end face 24c. The tip part of the lead part 41a of the first wire which extended out heads towards the wire connection part 151b of the first terminal 151, then the wire connection treatment such as soldering and the like is done. Also, the lead part 42a of the second wire guided to the second terminal passage 24b5 from the coil part 40 extends downwards in Z-axis direction along the outer end face 24c. The tip part of the lead part 42a of the second wire which extended out heads towards the wire connection part 152b of the second terminal 152, then the wire connection treatment such as soldering and the like is done.

In the present embodiment, the first terminal 151 and the second terminal 152 are same as the terminals 151 and 152 shown in FIG. 4A or FIG. 4B. The mounting parts 151a and 152a of the terminals 151 and 152 are adhered to the mounting face 24a positioned near the outer end face 24c of the collar part 24 and separate from each other in predetermined distance along Y-axis direction. Also, the wire connection parts 151b and 152b of the terminals 151 and 152 are adhered to the outer end face 24c positioned near the mounting face 24a of the collar part 24, and separate from each other in predetermined distance along Y axis direction.

Note that, although it is not shown in FIG. 4C, the third terminal and the fourth terminal are in similar relation as in case of the first terminal 151 and the second terminal 152, and these have same shape and have mounting part and the wire connection part.

The mounting parts of the third terminal and the fourth terminal are adhered to the mounting face 26a positioned near the outer end face 26c of the collar part 26, and are separated in predetermined distance along Y-axis direction. Also, the wire connection parts of the third terminal and the fourth terminal are adhered to the outer end face 26c positioned near the mounting face 26a of the collar part 26, and are separated in predetermined distance along Y-axis direction.

In the present embodiment, a third terminal guiding passage 26b4 is formed at the center part of an edge along Y-axis direction formed between the opposite face 26b of the mounting face and the inner face 26d of the second collar part 26. The third terminal guiding passage 26b4 is formed in an angle on the opposite mounting face 26b of the mounting face from the edge of the inner face 26d of the second collar part 26 towards the edge of the outer end face 26c where the third terminal is provided. Also, a fourth terminal guiding passage 26b5 is formed at the center part of an edge along Y-axis direction formed between the opposite face 26b of the mounting face and the inner face 26d of the second collar part 26. The fourth terminal guiding passage 26b5 is formed in an angle on the opposite mounting face 26b of the mounting face from the edge of the inner face 26d of the second collar part 26 towards the edge of the outer end face 26c where the fourth terminal is provided. These passages 26b4 and 26b5 intersect at the center part of the edge along Y-axis direction formed between the opposite face 26b of the mounting face and the inner face 26d of the second collar part 26, and are separated at an edge formed between the opposite face 26b of the mounting face and the outer end face 26c.

The lead part 41b of the first wire guided to the third terminal passage 26b4 from the coil part 40 extends downward in Z-axis direction along the outer end face 26c. The tip part of the lead part 41b of the first wire which extended out heads towards the wire connection part of the third terminal, then the wire connection treatment such as soldering and the like is done. Also, the lead part 42b of the second wire guided to the fourth terminal passage 26b5 from the coil part 40 extends downward in Z-axis direction along the outer end face 26c. The tip part of the lead part 42b of the second wire which extended out heads towards the wire connection part of the fourth terminal, then the wire connection treatment such as soldering and the like is done.

In the coil device 310 of the present embodiment, the wire connection parts (151b and 152b are only shown in the figure) of the wires 41 and 42 are not positioned to the mounting face 24a of the first collar part 24 and the mounting face 26a of the second collar part 26, but are positioned to the outer end faces 24c and 26c of the collar parts 24 and 26.

In the present embodiment, the lead part 41a of the wire 41 heading towards the coil part 40 from the first terminal 151 and the lead part 42a of the wire 42 heading towards the coil part 40 from the second terminal 152 are placed in close proximity at least between the inner face 24d of the collar part 24 and the coil part 40. Further, the crossing part 43 is formed at the predetermined position along the core axis direction of the core 22. By constituting as such, the mode conversion property is improved. Also, in the present embodiment, the lead part 41b of the wire 41 heading towards the coil part 40 from the third terminal and the lead part 42b of the wire 42 heading towards the coil part 40 from the fourth terminal are placed in close proximity at least between the inner face 26d of the collar part 26 and the coil part 40. Further, the crossing part 43 is formed at the predetermined position along the core axis direction of the core 22. By constituting as such, the mode conversion property is improved.

Note that, the present invention is not to be limited to the aforementioned embodiments, and it may be modified variously within the scope of the present invention.

For example, in the above mentioned embodiments, the first collar part 24 and the second collar part 26 have the same constitution, but these may have different constitution. For example, the first collar part 24 may have the constitution shown in FIG. 1 and FIG. 2, and the second collar part 26 may be constituted as any one of FIG. 4A to FIG. 4C. Alternatively, the first collar part 24 may be constituted as any one of FIG. 4A to FIG. 4C, and the second collar part 26 may be constituted as any one of FIG. 4A to FIG. 4C but different from the first collar part 24. Also, either one of the first collar part 24 and the second collar part 26 may be constituted as shown in FIG. 1 and FIG. 2, or as any one of FIG. 4A to FIG. 4C, and the other collar part may be constituted as conventional collar part.

Further, in the aforementioned embodiments, the common guiding passages 24b1, 26b1, 24e1, and 26e1 or the terminal guiding passages 24b4, 24b5, 26b4, and 26b5 which are formed to the collar part 24 or 26 may be formed to inner face or side face of the board 30. By forming the guiding passages to the board 30, there is no need to form the guiding passages to the collar parts 24 and 26 hence the volume reduction of the magnetic core is suppressed, and the magnetic properties can be improved.

### EXAMPLE

Hereinafter, the present invention is further described based on detailed examples, but the present invention is not to be limited thereto.

### Example 1

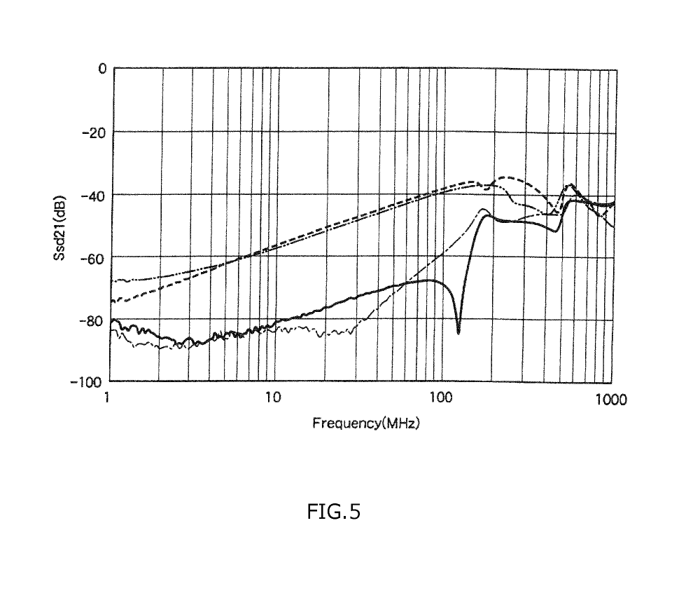

As similar to the second embodiment, the coil device 110 shown in FIG. 4A was produced. For this coil device 110, S parameter property, particularly Ssd21which indicates the mode conversion property was measured by a test defined by OPEN ALLIANCE. The result is shown in a bold line of FIG. 5.

### Example 2

As similar to the third embodiment, the coil device 210 shown in FIG. 4B was produced. For this coil device 210, as similar to Example 1, Ssd21 was measured by a test defined by OPEN ALLIANCE. The result is shown in a dot-dash line of FIG. 5.

### Comparative Example 1

The coil device 410 shown in FIG. 4D was produced as similar to Example 2 except for following. For the coil device 410, the one lead part 41a of the first wire and the one lead part 42a of the second wire were respectively guided to passages 24e1 and 24e1 of the first collar part 24. Also, the other lead part 41b of the first wire and the other lead part 42b of the second wire were respectively guided to the passages 26e1 and 26e1 of the second collar part 26.

For the coil device 410, Ssd21 was measured as similar to Example 1. The result is shown in a dot line of FIG. 5.

### Comparative Example 2

The coil device was produced as same as Example 1 except for the following. For this coil device, the crossing part 43 was not formed of which the first wire 41 and the second wire 42 cross against each other in the middle of the core 22 of the coil device shown in FIG. 4A according to Example 1. For this coil device, Ssd21 was measured as similar to Example 1. The result is shown in two-dot chain line.

### Evaluation

Examples 1 and 2 compared to Comparative examples 1 and 2 were able to reduce Ssd21 across the range of low frequency and high frequency which is indicated in a horizontal axis. Since Ssd21 can be reduced, for the coil device of Examples, differential signals were not converted to common mode, thus exhibited good property as a common mode filter.

Also, by comparing Examples 1 and 2 with Comparative examples 1 and 2, the present inventors have found following. That is, the mode conversion property was improved as the lead part heading towards the coil part from the terminal and the lead part heading towards the coil part from the terminal were placed in close proximity at least between the inner face of the collar part and the coil part (Examples 1 and 2), and also by providing the crossing part in the middle of the core part.

Note that, in the aforementioned Examples 1, 2 and Comparative example 1, the crossing part 43 is formed in the middle of the coil part 40, but in Comparative example 2, the crossing part 43 is not provided in the middle of the coil part. Also, for the coil device shown in FIG. 1 to 3 and FIG. 4C, it has been confirmed that the same result as the coil device of FIG. 4A can be obtained.

### DESCRIPTION OF THE REFERENCE NUMERAL

10, 110, 210, 310, 410 . . . Coil device

20, 120, 220, 320 . . . Drum core

22 . . . Core

24 . . . First collar part

24a . . . Mounting face

24b . . . Opposite face of mounting face

24b1 . . . First common guiding passage

24b2 . . . Guiding face

24b3 . . . Wire connection step face

24b4 . . . First terminal guiding passage

24b5 . . . Second terminal guiding passage

24c . . . Outer end face

24c1 . . . Terminal installation face

24d . . . Inner face

24e . . . Side face

24e1 . . . First common guiding passage

26 . . . Second collar part

26a . . . Mounting face

26b . . . Opposite face of mounting face

26b1 . . . Second guiding passage

26b2 . . . Guiding face

26b3 . . . Wire connection step face

26c . . . Outer end face

26c1 . . . terminal installation face

26d . . . Inner face

26e . . . Side face

26e1 . . . Second common guiding passage

30 . . . Board

40 . . . Coil part

41 . . . First wire

41a . . . One lead part

41b . . . Other lead part

42 . . . Second wire

42a . . . One lead part

42b . . . Other lead part

43 . . . Crossing part

51, 151 . . . First terminal

51a, 151a . . . Mounting part

51b, 151b . . . Wire connection part

51c . . . Terminal main body

52, 152 . . . Second terminal

52a, 152a . . . Mounting part

52b, 152b . . . Wire connection part

52c . . . Terminal main body

53, 153 . . . Third terminal

53a, 153a . . . Mounting part

53b, 153b . . . Wire connection part

53c . . . Terminal main body

54, 154 . . . Fourth terminal

54a, 154a . . . Mounting part

54b, 154b . . . Wire connection part

54c . . . Terminal main body

What is claimed is:

1. A coil device comprising
a core,
a first collar part and a second collar part each provided at both sides along the axis direction of the core,
a coil part at least having a first wire and a second wire which are wound around the core,
a first terminal connected with one lead part of the first wire and provided to the first collar part,
a second terminal connected with one lead part of the second wire and provided apart from the first terminal to the first collar part,
a third terminal connected with other lead part of the first wire and provided to the second collar part,
a fourth terminal connected with other lead part of the second wire and provided apart from the third terminal to the second collar part, wherein
the one lead part of the first wire heading towards the coil part from the first terminal and the one lead part of the second wire heading towards the coil part from the second terminal are placed in close proximity at least between the coil part and an inner face of the first collar part, and
the first wire and the second wire form a crossing part of which the first wire and the second wire are crossing against each other in the middle of the core.

2. The coil device according to claim 1, wherein the other lead part of the first wire heading towards the coil part from the third terminal and the other lead part of the second wire heading towards the coil part from the second terminal are placed in an close proximity at least between the coil part and the second collar part.

3. The coil device according to claim 1, wherein the first collar part is provided with a first common guiding passage which guides the one lead part of the first wire and the one lead part of the second wire together towards outside from the inner face of the first collar part.

4. The coil device according to claim 2, wherein the second collar part is provided with the second common guiding passage which guides the other lead part of the first wire and the other lead part of the second wire together towards outside from the inner face of the second collar part.

5. The coil device according to claim 1, wherein the first collar part is provided with a first terminal guiding passage which guides the one lead part of the first wire towards outside from the inner face of the first collar part and a second terminal guiding passage which guides the one lead part of the second wire towards outside from the inner face of the first collar part, and
the first terminal guiding passage and the second terminal guiding passage are in close proximity at the inner face of the first collar part.

6. The coil device according to claim 1, wherein the second collar part is provided with a third terminal guiding passage which guides the other lead part of the first wire towards outside from the inner face of the second collar part and a fourth terminal guiding passage which guides the other lead part of the second wire towards outside from the inner face of the second collar part, and
the third terminal guiding passage and the fourth terminal guiding passage are in close proximity at the inner face of the second collar part.

7. The coil device according to claim 1 further comprising a flat board extending between an opposite face of a mounting face of the first collar part and an opposite face of a mounting face of the second collar part.

8. The coil device according to claim 7, wherein the flat board is provided with a flat board first common guiding passage which guides the one lead part of the first wire and the one lead part of the second wire together towards outside from the inner face of the first collar part.

9. The coil device according to claim 7, wherein the flat board is provided with a flat board second common guiding passage which guides the other lead part of the first wire and the other lead part of the second wire towards outside from the inner face of the second collar part.

10. The coil device according to claim 1, wherein a wire length of the one lead part of the first wire from the coil part to the first terminal is approximately same as a wire length of the one lead part of the second wire from the coil part to the second terminal.

11. The coil device according to claim 1, wherein a number of winding of the first wire of the coil part is same as a number of winding of the second wire of the coil part.

12. The coil device according to claim 1, wherein a winding density of the first wire and a winding density of the second wire decrease in the middle of the core and forms an exposed area of the core in which a surface of the core is exposed, and
the crossing part is form at the exposed area.

13. The coil device according to claim 1, wherein wire connecting parts of the first terminal, the second terminal, the third terminal, and the fourth terminal are positioned other than the mounting face of the first collar part and the second collar part.
